(19) United States
(12) Patent Application Publication
(10) Pub. No.: US 2004/0152479 A1
(43) Pub. Date: Aug. 5, 2004

(54) Data channel procedure for systems employing frequency diversity

(76) Inventors: Bradley J. Rainbolt, Sunrise, FL (US); Anthony Rodrigues, Lighthouse Point, FL (US)

Correspondence Address: Scott M. Garrett, Motorola, Inc., Law Department, 8000 West Sunrise Boulevard, Fort Lauderdale, FL, 33322, US

(21) Appl. No.: 10/355,336

(22) Filed: Jan. 31, 2003

(51) Int. Cl. H04B 7/00; H04B 1/00

(52) U.S. Cl. 455/506; 455/42

(57) ABSTRACT

The invention relates to a method for use in wireless data communications for facilitating two way data transfer between devices employing frequency diversity. It is generally suited toward units accomplishing frequency diversity by way of frequency hopped spread spectrum operation. The basic unit of the invention is an individual data frame whose reliability is enhanced by a unique combination of redundant error correction coding, time-, and frequency-diversity. The invention further extends the individual data frame concept to a complete asynchronous data message which comprises both a call establishment phase and a traffic phase. The traffic phase extends the basic data frame to encompass a complete data message. That message, which already contains the enhancements of the basic data frame, is further enhanced by repeating itself as many times as can fit in the transmission. In order to allow asynchronous operation, the call establishment phase is sent using a known frequency sequence, while the traffic phase is pseudorandomly ordered in such a manner that the entire transmission appears pseudorandom, and all frequencies are employed equally on average.

### FIELD OF THE INVENTION

The invention relates to wireless system communications. More particularly, the invention relates to a data channel procedure for facilitating the delivery of communications between digital devices that utilize frequency hopping.

### BACKGROUND OF THE INVENTION

The wireless industry has grown at a tremendous pace over the past few years. Wireless communication has become a standard part of every day life. Most people utilize some variant form of wireless communications such as Global System for Mobile communication (GSM), Universal Mobile Telecommunications System (UMTS), Carrier Detection Multiple Access (CDMA) and 802.11 in various aspects of daily living.

Generally, radio systems are designed for a certain area of coverage or footprint. These areas are generally referred to as cells. Cells enable the reuse of similar frequencies by multiple sources to support services in metropolitan areas that are some distance apart. The geographic size of cells are not necessarily consistent throughout a given area and may vary due to frequency and power level, topography of the area, time of day and so forth. Communications within these cells take advantage of a concept known as Demand Assigned Multiple Access (DAMA). DAMA enables multiple devices to access a network in a shared manner on a demand basis. Basically, devices access the network on a first come, first serve basis. Within a wireless network, there are a number of ways in which multiple access can be provided to end-users. At the most basic level, there is a Frequency Division Multiple Access (FDMA) methodology, which is essentially the starting point for all wireless communications, given that each cell must be separated by frequencies to avoid interference among wireless devices.

Yet another communication methodology which is relatively new and has its root in spread spectrum radio is known as Code Division Multiple Access (CDMA). Spread spectrum radio spreads the bandwidth of a transmitted signal over a spectrum of radio frequencies. The combined spectrum of radio frequencies is usually much wider than what is required to support the narrow band transmission of the signal. Spread spectrum uses two techniques namely, Direct Sequence (DS) and Frequency Hopping (FH). In brief, DS spread spectrum is a packet radio technique in which the narrow band signal is spread across a wider carrier frequency band. In other words, the signal information is organized into packets, each of which is transmitted across a wider carrier band frequency in a redundant manner i.e. packets are sent more than once. Multiple transmissions can then be supported. The transmissions from specific terminals are identified by a unique code such as, a 10 bit code that is pre-pended to each data packet. Most newer technologies such as CDMA, 802.11 and cordless applications use Direct Sequence Spread Spectrum (DSSS). However, blue tooth and the present invention utilize Frequency Hopping Spread Spectrum (FHSS). In some instances 802.11 utilizes the FH mode. FHSS involves transmission of short bursts of packets within the wide band carrier over a range of frequencies. Essentially, the transmitter and receiver hop from one frequency to another in a choreographed hop sequence and a number of packets are sent at each frequency. The hop sequence is controlled by a centralized base station antennae, in the case of a land mobile trunked system such as cellular. An alternative mode of communications may be required when a cellular system is unavailable, due to busy cells or lack of coverage in a given area. This mode is commonly referred to as “talk-around” or “direct mode”, and allows two wireless devices to communicate directly with one another, similar to ordinary two-way radios. An embodiment of the present invention is directed to this talk-around mode of operation.

When operating at high power in the unlicensed but regulated Federal Commision for Communication (FCC) band of 900 MegaHertz and 2.4 GigaHertz, it is necessary to prevent interference with other users of the same band. For instance, the 900 Mhz band is utilized by cordless telephones and the 2.4 GHz Industrial Scientific and Medical band (ISM) is utilized by IEEE 802.11 or bluetooth compliant wireless devices. Inherent non interference can be achieved by utilizing spread spectrum, which as previously discussed comprises DS technology or FH technology.

For a multitude of reasons the range of voice information transfer using FH is somewhat limited. There is a need for a data feature to cope with functions and applications such as, text messages, multi-player games and GPS location information. Furthermore, because the range for data transmission can be designed to exceed that of voice, it is possible to send text messages when voice functions are no longer operational. For example, in the case of a cell phone or other voice personal communication device, the receiving unit may be able to receive at least a caller identification even though the voice call is inaudible. At a minimum, the user will thus be able to identify the party that was attempting to make contact.

The availability of a system and method to provide reliable transmission of blocks of data is required. For example, an originating mobile device's private identification needs to be reliably transmitted. In attempting to accomplish reliable transmission of private identification, certain problems arise with respect to signal detection, transmission message lengths, communication range and under utilization of frequencies in the frequency hopping set. These shortcomings are related to data communication limitation, along with the requirements of meeting the guidelines for the FCC, addressed in U.S. 47CFR part 15.247-15.249, as well as, similar regulations in other countries. As such, there is a need for a system and method to address the use of frequency hopping for data channels. There is also a need for providing performance gain and reliability in the transfer of data.

### BRIEF SUMMARY OF THE INVENTION

The invention relates to a system and method for use in wireless system communications. More particularly, the invention relates to facilitating data communications between digital devices that utilize frequency hopping spread spectrum coding.

The core of the invention is the development of a frequency-hopped data frame which reliably delivers a single data unit adequate for the minimum data size required by a given application. For example, such a data unit might be a device's identification number. By applying forward error correction and repeat diversity, reliability and performance gain are realized. Furthermore, by repeating coded and repeated data on multiple frequencies, as is required in Frequency Hopped (FH) systems, the additional benefit of frequency diversity is achieved. Frequency diversity provides gain in terms of interference avoidance and uncorrelated channel fading. This basic data frame can be utilized to embed data (such as a device identifier) in other applications, such as digital FH voice transmission. In a further aspect of the invention, the basic data frame can be concatenated with others to provide a complete data transmission protocol between FH devices. The method of the present invention provides offline operations outside the fixed network infrastructure, utilizes a weighted pseudo random generator to de-emphasize the selection of known call setup frequencies in a transmission packet and transmits data traffic packets using pseudorandomly ordered frequencies, thus realizing frequency diversity. This method applies to two or more FH devices communicating directly with each other without ever communicating on a network, for example digital two-way data/voice radios.

### BRIEF DESCRIPTION OF THE DRAWINGS

FIG. 1 is a block diagram of an exemplary wireless communication system in which the invention can be practiced;

FIG. 1B is a block diagram illustrating remote units in direct communication outside of a network in a talk-around mode.

FIG. 2 is an electrical blocked diagram of an exemplary remote unit in accordance with the invention;

FIG. 3 is a block diagram of a representative digital channel procedure for implementing the basic frequency-hopped data frame;

FIG. 4A is an illustration of frames of a complete data transmission protocol in which there is a padding with zeros, without the repetition of the message; and

FIG. 4B is an illustration of the improved scenario of the invention, depicting frames in a digital channel procedure transmission signal in which there is a padding with zeros along with repetitions of the entire message.

### DETAILED DESCRIPTION OF THE INVENTION

The invention provides a unique system and method for handling and transmitting data between remote mobile units. The invention is applicable in wireless system communications. Particularly, the invention relates to facilitating communications between digital devices that utilize spread spectrum coding for the transmission of data.

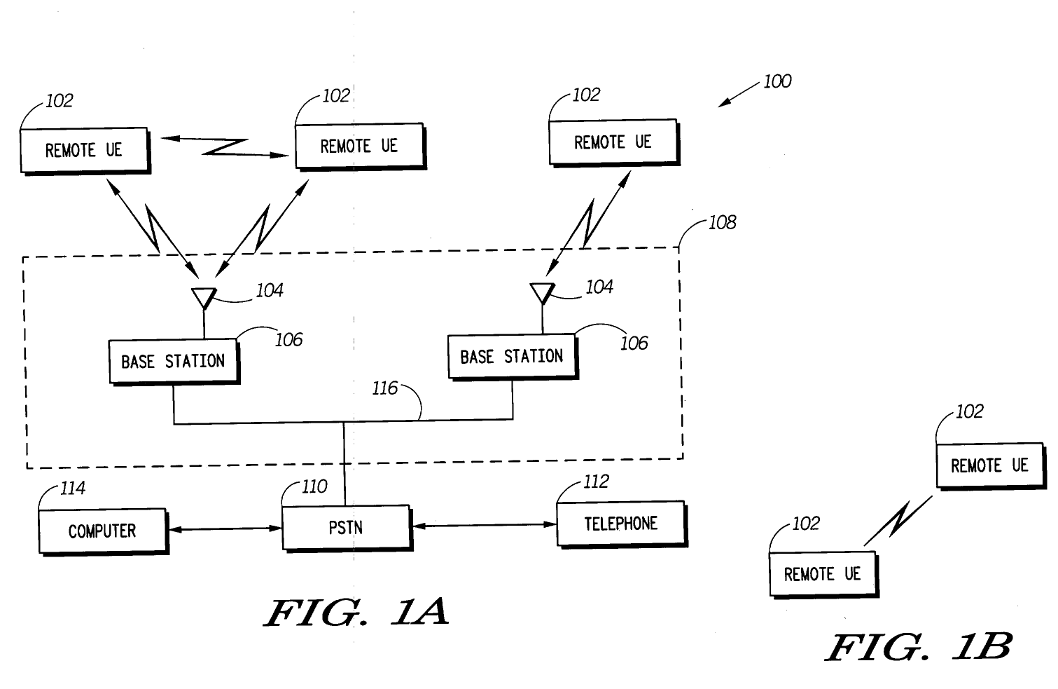

Referring initially to FIG. 1, a blocked diagram illustrates a wireless communication system, environment around which the invention can be practiced. It should be noted that the present invention can also be practiced directly between devices that do not ever operate in the illustrated system and will be discussed with reference to FIG. 1B. As shown in FIG. 1, a fixed portion 108 includes one or more base stations 106, which provide communication to a plurality of remote user equipment 102. The base stations 106 coupled by communication link 116 preferably communicates with the user equipment 102 utilizing conventional radio frequency techniques. One or more antennae 104 provide communication from the base stations 106 to the remote user equipment 102. The base stations 106 preferably also receive RF signals from the plurality of remote user equipment units 102 via antennae 104.

The fixed portion 108 of the communications network 100 is coupled to a public switch telephone network (PSTN) 110 for receiving and sending messages to other device types like telephone 112 and computer 114. Calls or information initiated by or destined for a remote user equipment 102 can be received by or originated from a device such as telephone 112 or computer 114. Those skilled in the art recognize that alternate types of networks, for example, local area networks (LAN), wide area networks (WAN) and the Internet, can be used for receiving or sending selective call information to the wireless network 100. A computer such as computer 114 can also serve as a central repository for various applications and information utilized by the wireless communication system.

It will be further appreciated that the invention is applicable to other types of wireless communication systems including dispatch systems, cellular telephone systems and voice and/or data messaging systems.

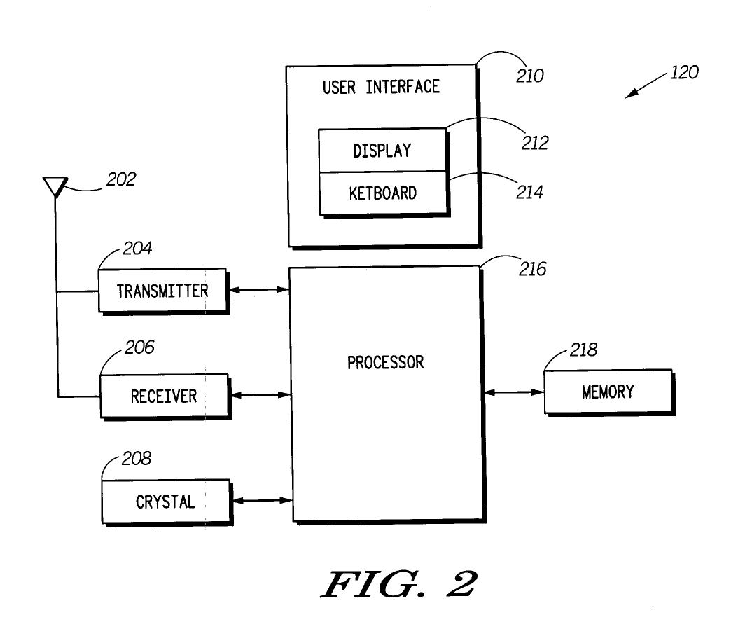

FIG. 1B illustrates the alternative communication mode of talk-around. In talk-around mode, two or more remote user equipment 102 communicate directly with one another outside of the network. This invention provides particular advantages in non-network communications between user equipment 102. In particular, an embodiment of the present application provides direct communication for remote equipment such as digital walkie-talkies that are not associated with any network. An exemplary remote user equipment 102 that can be utilized for the present invention will be discussed with reference to FIG. 2.

FIG. 2 illustrates an exemplary remote user equipment 102 and its various components. The remote user equipment 102 comprises an antenna 202 that is utilized for receiving inbound messages and for transmitting outbound messages. The antenna 202 is coupled to a transmitter 204 and a receiver 206. Both the transmitter 204 and the receiver 206 are coupled to a processor 216 for processing information relating to outbound and inbound messages and for controlling the remote user equipment 102 in accordance with the invention. A user interface 210 is operably coupled to the processor 216 for providing user interaction and feedback. In an embodiment of the invention, the user interface 210 comprises a display 212 and a keyboard 214. The display 212 provides a user with operative information and feedback from the processor 216. The keyboard 214 enables a user to provide input or response to the processor 216. Other methods and systems for user interaction and feedback could also be used to accomplish the objects of the invention. A crystal oscillator 208, provides conventional timing to the processor 216 and other components of the remote user equipment 102. Processing is performed by the processor 216 in conjunction with memory 218. The memory 218 comprises software instruction and data for programming and operating the remote user equipment 102 in accordance with the invention. Remote user equipment 102 operates to communicate to a base station 106 or other remote user equipment 102. Regardless of the target it becomes necessary to transmit blocks of data with a high degree of reliability, so as to enable a call recipient to identify a caller even when voice is inaudible.

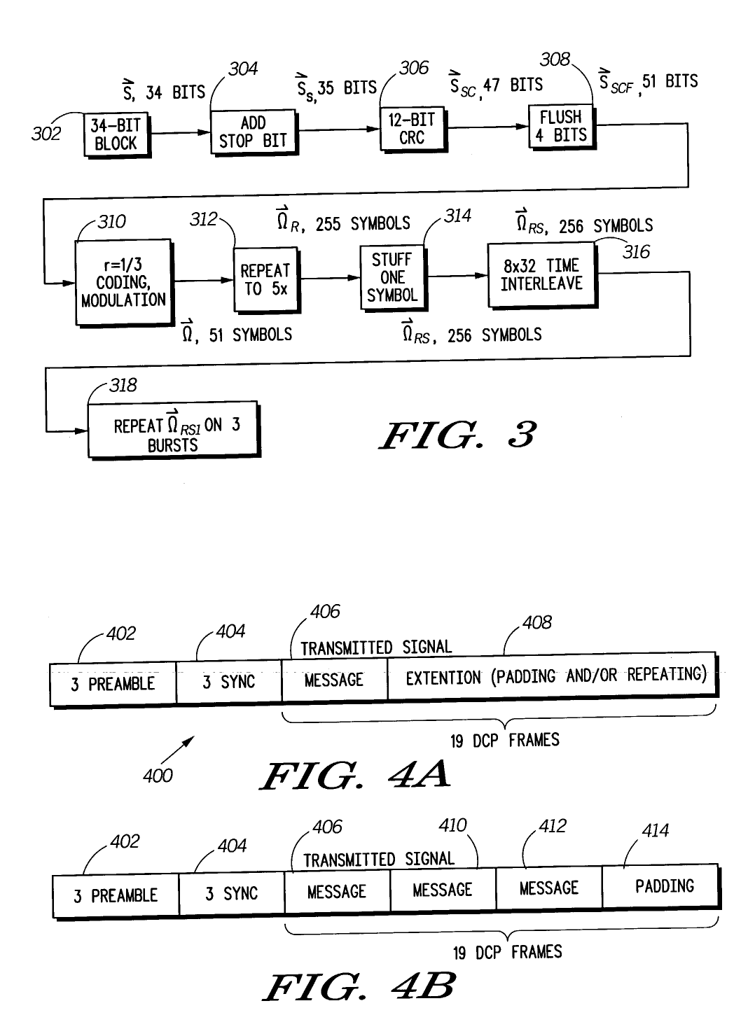

Reliable transmission of data will be discussed with reference to FIG. 3. In particular, in an embodiment of the invention the reliable transmission of a basic unit of data, such as the originating mobile equipment's private identification will be discussed. However, it will be appreciated by those skilled in the art that the system and method of the invention are equally applicable to other data items such as text messages. Generally, the data associated with the identification of a mobile user equipment should be receivable at very low Signal-to-Noise Ratios (SNR). In other words, there should be some type of communication that can take place when the SNR is not high enough for good voice quality. If a party is unable to intelligibly hear the caller during digital voice operation, the called party should at least know who called. Furthermore, users may also choose to communicate using short text messages when voice communication is not feasible, and the delivery of such message is made more reliable by the present invention.

In order to achieve the goal of reliable delivery, a Data Channel Procedure (DCP) is implemented wherein overhead is applied to the data information signal. The mechanism used in this process may include one or more of forward error-correction (FEC), repeat diversity and cyclic redundancy check (CRC) code.

FIG. 3, illustrates a DCP designed for systems to achieve frequency diversity for transmission signals. In an embodiment of the invention, the modulation method utilized is an orthogonal Frequency Shift Keying (8-FSK) at 3200 symbols per second, with non-coherent detection. A symbol, results from the modulated coding of bits of data that are to be transmitted. In the illustrated embodiment 300, an operating frequency in the ISM band of 902-928 MHz with a frequency hopping carrier spacing of 50 KHz is utilized. Each hop-set consists of 50 carriers and because of FCC regulations each of these frequencies must be uniformly utilized.

In the exemplary DCP 300, at step 302, a 34-bit block of data √ is to be sent. This data could be the originator's PID, text message or some other data. To aide in the description of the invention, various notations and symbols are utilized in this discussion. For instance, a vector denoted with “S” refers to a vector of bits, while a vector denoted with “1” refers to a vector of 8-FSK symbols. Subscripts on the vectors are further provided to represent functions that have been performed on the vector. For example the subscript ‘S’ indicates that the data bits of an associated vector have had Stop Bits added, ‘C’ indicates that CRC has been performed, ‘F’ indicates that flush bits have been added and ‘R’ indicates that one or more Repeats have been performed.

Turning to the illustrative DCP 300, a stop bit is added to the 34 bits of data √ at step 304, resulting in 35 bits of data, √_{S}. Following this, a 12-bit CRC is performed at step 306 utilizing a generator polynomial:

g(x)=1+x+x²+x³+x¹¹+x¹²

to yield a 47-bit block √_{SC}.

Because a convolutional encoder with four memory elements will be used, it is necessary that four flush bits of zeroes are appended to enable the convolutional encoder to finish in a known state. The four flush bits are appended at step 308 to the 47-bit block ∞_{SC} to give a block √_{SCF} of length fifty-one. At step 310, the block √_{SCF} passes through a rate 1/3 convolutional encoder. The encoder essentially converts bits to symbols, using an 8-FSK mapping. In the exemplary DCP 300, there is a mapping of three bits per symbol however, because there is also ⅓ coding taking place, each bit is ultimately represented by a symbol after the 8-FSK mapping, thus resulting in fifty-one symbols Σ.

The next requirement in DCP is the need for time diversity, which will enable multiple instances of the message block to be created. In order to create time diversity, the 51 symbols of step 310 are repeated five times, at step 312 yielding 255 symbols Σ_{R}. A single symbol is added on at step 314 to create a 256 symbol length vector Σ_{RS}. An interleaver 8×32 block is used at step 316 to obtain a length-256 vector Σ_{RSI}. The 8×32 time interleave block provides scrambling of the symbols and aides in overcoming de-correlation, fading and other similar problems. Essentially, time interleave scrambles a message by re-ordering the signal. The next step is the application of frequency diversity.

Frequency diversity enables the ability to improve the chance of successful delivery of a message block, while providing distinction between the repeated blocks. In order to create frequency diversity, the length-256 vector Σ_{RSI} can be repeated on any number of bursts. The number N of bursts on which Σ_{RSI} is repeated, is flexible. Each repetition provides diversity gain and thus an improvement in performance. Although each repeat also slows down the supported data rate, this slow down is actually necessary in order to achieve the desired range and performance. In an embodiment of the invention, an N value of three is chosen at step 318. This N burst frame creates the basic data unit. Since, in FH systems, each burst is on a different frequency, frequency diversity is achieved. This data unit can be inserted into other FH streams, such as voice.

The next aspect of the invention is the extension of the basic data unit into a complete data transmission protocol. The particulars of this compliance process will be discussed with reference to FIG. 4A.

In certain applications the sending of short messages create certain problems, resulting from the requirements of FCC regulations. In particular, the requirement of an even distribution and utilization of every frequency in a spread spectrum. Each hop-set in certain applications of the 900 MHZ ISM band contains fifty frequencies or channels. It is required by the FCC rules that transmissions at a minimum, uniformly utilize each of the fifty frequencies. In order to synchronize the mobile devices in a manner which does not excessively drain power, six (6) of the fifty frequencies in a hop-set are sent at the beginning of every transmission in order to achieve call setup. Turning to FIG. 4A, the frequencies are sent in a fixed pattern as a preamble 402 and a sync 404. During voice or data traffic, the selection of these fixed pattern frequencies are de-emphasized by the pseudorandom generator so that overall frequency distribution remains uniform. For example, in voice transmission there are six frequencies that are de-emphasized throughout the majority of a transmission in order that all frequencies be used uniformly. Long transmissions are actually crucial in balancing out the frequency utilization. However, with data, the messages can be short and the transmission correspondingly short. This then limits the ability to balance out frequency utilization. A solution is provided through padding and/or repetition of the data message in such a manner that a fixed transmission length is implemented.

With short messages such as text, there is a good chance that typical messages would severely skew the balance of frequency utilization. For example, consider a message of twenty characters, which is a typical message length. Since as previously described, each DCP frame can hold 4.25 characters. The twenty-character message would thus require five DCP frames. A DCP frame is transmitted on three hops, therefore, these five DCP frames will then require fifteen frequency hops. For synchronization purposes a typical message utilizes fifty frequencies in a hop-set. This suggests that there would be an inability to balance the utilization of the fifty frequencies.

Generally, in an effort to balance frequency distribution there is a de-emphasis by the pseudorandom generator of the selection of six preamble and synch frequencies, during the traffic portion of the transmission, such that they are less likely to be chosen as one of the frequencies utilized for sending the message. In other words, each preamble and synch, a total of six out of the fifty frequencies used for a message, will be sent exactly once. The remaining forty-four frequencies from the message would be sent on average 15/44=0.34 times each without such de-emphasis. Thus eliminating any chances of balancing the frequency.

This problem of frequency balancing is addressed by the present invention as illustrated and discussed with reference to FIG. 4A. As shown, any message is extended to nineteen DCP frames regardless of the actual message length. In other words, each message is placed on fifty-seven frequencies (19 DCP*3 frequency hops per DCP). In effect, each message would thus be extended to a message of 4.25*19=80.75 characters. The Preamble 402 of three frequencies and Sync 404 also of three frequencies, are de-emphasized in their selection during traffic. At traffic frequencies, there is a lower probability of being selected than the remaining forty-four frequencies of a typical fifty frequency message. The amount of de-emphasis can be found by looking at the average number of times a frequency is used. The probability for selection of a frequency during traffic by a pseudo random generator to transmit the message can be expressed as follows:

$${P}_{r} ( choose {f}_{i} ) = \{ \begin{matrix}0.00456 , {f}_{i} is Preamble or Sync frequency \\ 0.02211 , {f}_{i} i is not aPreamble or Sync \\ frequency\end{matrix}$$

During a transmission there are six Preamble and Sync bursts plus the fifty-seven traffic bursts, for a total of sixty-three bursts in the modified message. With the weighting represented by the equation above for the traffic frequencies, each of the fifty channels in the hop-set will be used. The average usage will be 63/50=1.26 times, which results in a frequency utilization that is balanced.

For messages which are short enough, it would be beneficial to use that necessary padding for additional message repetition, as opposed to simply padding with zeros, as shown in FIG. 4B. When the message is repeated, the CRC on each DCP frame can be used to decide if that repetition is decoded correctly. The transmittal signal 410 of FIG. 4B contains a three burst preamble 402, a three burst sync 404, text message blocks 406, 410, 412 that are identical repetitions and a padding 414. As shown, the nineteen DCP frames of the signal are used to repeat the text message as many times as possible with a zero padding on the end.

As previously discussed the number of bursts for data repeats that was selected in an embodiment of the invention is three. As such the message 406 is repeated as messages 410 and 412. This DCP implementation of the invention results in a high reliability transmission of the blocks of the message data.

The benefits of the DCP of this invention are further illustrated by results of an exemplary simulation. The environment for the simulation was Rayleigh fading channel using a mobile unit speed of 3 MPH. The fading on each of the frequency hops was taken as independent. The receiver used a bank of matched-filters, one for each of the eight FSK frequencies, to generate a set of eight complex statistics during each symbol interval. The sets of statistics corresponding to a symbol which was repeated within a hop and then on different hops, were square-law combined.

The combined statistics of those symbols were then input into a Viterbi decoder. The decoder used square law combining of the branch metrics to forming a path metrics.

In the above mentioned environment, the following results were obtained for the reception of an originating mobile's Private Identification (PID). One of the guidelines in the simulation was that if any bits of the PID were in error, the entire PID would be rejected. It was observed that for a very low E_{S}/N₀ of 3 dB, where E_{S} represents symbol energy and No represents noise spectral density, the PID is received 99% of the time. At 6 dB the PID is received more than 99.9% of the time. To further illustrate the benefits and operations of the invention, the transmission of message of varying character lengths are evaluated in the previously discussed simulation environment, utilizing the inventive DCP design.

In particular, the probability that an entire message is not decoded correctly is considered, for messages of lengths seventeen, thirty-four, fifty-one and sixty-eight characters. The value of E_{S}/N₀ for which the entire message is correctly received more than 99% of the time will be used as a metric here.

As discussed above an embodiment of the invention utilizes nineteen DCP frames for the transmission of a message, with 4.25 characters per DCP. As such, the 17-character message, which requires 4 DCP (17/4.25) will be transmitted four times within the 19 DCP message length. The 17-character message requires an E_{S}/N₀ of about −1 dB, a value far below the point at which Preamble and Sync are received correctly. The 34-character message will be sent twice, and requires an E_{S}/N₀ of about 2 dB, which is still below the levels at which Preamble and Sync are reliably received. Generally, a large fraction of text messages would be within this range of 34 characters with a SNR of 2 dB.

The longer fifty-one and sixty-eight-character messages are only sent once during the 19 DCP message length. These require E_{S}/N₀ values between 6 dB and 7 dB, which is about the point at which Preamble and Sync are reliably received. Even at an E_{S}/N₀ of 4 dB, the messages are decoded correctly more than 90% of the time.

From the results, it is further demonstrated that messages are detected with very high reliability, high enough such that the limiting factor in text messaging will be the detection of Preamble and Sync at very low values of E_{S}/N₀.

The invention has been described in relation to particular embodiments which are intended in all respects to be illustrative rather than restrictive. Alternative embodiments will become apparent to those skilled in the art to which the invention pertains without departing from its scope.

From the foregoing, it will be seen that this invention is one well adapted to obtain all of the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

We claim:

1. A method for use in wireless communications for facilitating two-way data transfer between devices employing frequency diversity, comprising:
providing a basic data frame with a bit length sufficient to carry a minimum amount of information for a given application;
encoding said basic data frame through redundant forward error-correction coding;
repeating said encoded data to provide time diversity; and
further repeating said encoded data on multiple frequencies to provide frequency diversity and enhance frequency hopped spread spectrum capability.

2. The method as recited in claim 1, wherein said encoding of said basic data frame through forward error-correction coding, improves performance and reliability.

3. The method as recited in claim 1, wherein said repetition of said encoded data for time diversity, further enhances performance.

4. The method as recited in claim 1 further comprising packaging said basic data frame for application to non-data frequency hopped applications.

5. A method for wireless communication of a data message, comprising:
providing multiple basic data frames to encompass the data message;
fitting as many copies of the data message as possible within an overall transmission; and
padding the remainder of said overall transmission with a value in order to achieve a uniform transmission length.

6. A method as recited in claim 5, wherein said value utilized for said padding is zero.

7. A method for asynchronous wireless communications of data between devices utilizing frequency hopped spread spectrum operation, comprising:
a call-establishment phase, wherein said call-establishment phase utilizes a known frequency sequence;
a traffic phase; and
a pseudorandom sequence generator for providing a selection of said known frequency sequence;
wherein said selection by said pseudorandom sequence generator de-emphasizes said known frequency sequence during said traffic phase, such that all selected known frequencies are utilized equally on average.

8. A method for use in wireless communications for transmitting data comprising:
extending the traffic portion of a data transmission message to a transmission signal length that enables the balanced use of a plurality of frequencies;
de-emphasizing the selection of an initial subset of said plurality of frequencies during data traffic; and
repeating shorter messages at the remaining frequencies multiple times within said transmission signal length.

9. The method as recited in claim 8 wherein de-emphasizing the selection of said initial subset of said plurality of frequencies is achieved by utilizing a pseudo random generator.

10. The method as recited in claim 8 wherein said initial subset of said plurality of frequencies are represented within a first portion of said transmission signal length and, contain uniform control signals such as preamble and sync bursts.

11. A system for use in wireless packet data mode communications for providing two way data communications utilizing frequency hopping spread spectrum comprising:
a pseudo random generator component;
a basic data frame component;
a memory; and
a computing component;
wherein said pseudo random generator component operates to de-emphasize the use of one or more fixed frequencies in a transmission of data; and
wherein said computing component and said memory provide an operating environment for said pseudo random generator component, said basic data frame component, redundant forward error-correction encoding of basic data, repetition of encoded data for time diversity and a further repetition of encoded data on multiple frequencies.

12. A device for use in wireless communications comprising:
a transmitter;
a receiver;
a processing component; and
a memory
wherein said transmitter and receiver operate in conjunction with said processing component and said memory to transmit data utilizing frequency hopping spread spectrum;
wherein said processing component comprises:
a data frame; and
a pseudo random generator
wherein said data frame is subjected to redundant error-correction coding, repetition for time diversity and repetition on multiple frequencies for frequency diversity.

13. A device as recited in claim 12 further comprising an asynchronous data message, said asynchronous data message comprising:
a traffic phase; and
a call establishment phase.

14. A device as recited in claim 13, wherein said traffic phase extends said data frame to encompass said asynchronous data message.

15. A device as recited in claim 14, wherein said traffic phase is further enhanced by repeating said asynchronous data message as many times as can fit within a transmission.

16. A device as recited in claim 13, wherein said call establishment phase is transmitted using a known frequency sequence, and said traffic phase is pseudo randomly ordered, to provide a pseudo random transmission and employ all frequencies equally on average.
